(19) United States
(12) Patent Application Publication
(10) Pub. No.: US 2002/0111983 A1
(43) Pub. Date: Aug. 15, 2002

(54) Apparatus and method for determining and scheduling resources

(76) Inventors: Blair Cameron Hendrickson, Alpharetta, GA (US); Clair Dustin Crane, Alpharetta, GA (US); Douglas George Anderson, Cumming, GA (US)

Correspondence Address: Jason A. Bernstein, BERNSTEIN & ASSOCIATES, P.C., Embassy Row 400, Suite 495, 6600 Peachtree Dunwoody Road, N.E., Atlanta, GA, 30328-1649, US

(21) Appl. No.: 09/815,513

(22) Filed: Mar. 23, 2001

Related U.S. Application Data
(60) Provisional application No. 60/191,401, filed on Mar. 23, 2000.

(51) Int. Cl. G06F 9/00; G06F 9/46

(52) U.S. Cl. 709/104; 709/318

(57) ABSTRACT

A system architecture for managing event driven activities, the event driven activities are generated by a recipient's desire for a selected resource. The recipient is in communication with a Resource Manager. The Resource Manager in receipt and responsive to the recipient's request, generates a request for a resource allocation to satisfy the desire of the recipient for the resource. The Resource Manager formulates and transmits a request stimulus delineating the recipient desire for a selected resource allocation to a Publishing Engine. The Publishing Engine evaluates the Resource Manager's request in view of the available resources and transmits the evaluation to the Resource Manager. The Resource Manager, in communication with the Scheduling Engine, generates a schedule activity request. The Scheduling Engine, responsive to the schedule activity request and in concert with the Publishing Engine, generates an event activity schedule reflecting the recipient's desire for a selected resource.

### CROSS-REFERENCE TO RELATED APPLICATION

This application claims the benefit of U.S. Provisional Application Ser. No. 60/191,401, filed on Mar. 23, 2000, which is incorporated by reference herein.

### FIELD OF THE INVENTION

The present invention relates, in general, to a system architecture for managing event driven activities. In particular, the present invention relates to a system that provides attribute control of resources in cooperation with the distribution of the resource to a user or recipient.

### BACKGROUND OF THE INVENTION

Generally, schedules record events that are planned for execution at a selected date or time in the future. The means by which scheduling of events are recorded varies widely. One example of a recording means is a simple desktop calendar wherein the scheduler denotes an event that is of importance to the scheduler. A sophisticated means of recording events is to denote a plurality of events with the aid of a computer with memory or with a database having a software program installed thereon to manage the recording of events and the projection of the schedule on a computer monitor display. A more sophisticated means of recording events is to use a software program that identifies conflicting events and projects the results of the conflict(s) and the intended schedule on a computer monitor display.

Generally, existing scheduling software programs do not provide the managing of events or resolution of conflicts. A user of the currently available scheduling software programs must manually adjust the schedule until the conflicts are resolved or the user reaches a satisfactory compromise between the desired execution of events and the practical or convenient workable execution of events.

Attempts in the past to alleviate the burdensome task of technique the trial and error method of making schedule adjustments have focused on the “click and drag” of a computer cursor to adjust the time period of a selected event. Once this action had taken place, the scheduling program would re-compute the time periods of the whole schedule. This approach often resulted in multiple conflicts due to user inability to ascertain all of the scheduled events simultaneously.

It would be desirable to have event conflicts associated in scheduling resolved before the schedule is displayed to the user. It would be further desirable to have event time allocation and required resource data to implement the scheduled event incorporated or considered into the final schedule displayed to the user.

The following definitions are provided to aid the reader in understanding the terms used throughout the text, drawings, and claims:

Event—A requested or scheduled activity during a specific time duration; An action or occurrence, often generated by the user, to which a software program might respond. Key presses, button clicks, or mouse movements associated with a computer are examples.

Engine—A processor or portion of a program that determines how the software program manages and manipulates data. For example, a database engine contains the tools for manipulating a database.

Time allocation—A period of time dedicated to the execution of an event.

### SUMMARY OF THE INVENTION

The present invention is a system architecture for managing event driven activities. The event driven activities are generated by a user or a recipient's desire for a resource. The recipient is in communication with a Resource Manager. The Resource Manager is in communication with a Publishing Engine and a Scheduling Engine. The Resource Manager receives the request for a desired resource from the recipient. Responsive to that request, the Resource Manager generates a request for a resource allocation to the Publishing Engine. Responsive to the Resource Manager's request the Publishing Engine generates at least one data structure delineating the recipient's desire for an allocation of a selected resource. The Publishing Engine evaluating resource availability in cooperation with the selected resource allocation transmits the resultant to the Resource Manager. The Resource Manager, in communication with a Scheduling Engine, generates a schedule activity request. The Scheduling Engine responsive to the schedule activity request and in concert with the Publishing Engine generates an activity schedule reflecting the recipient's desire for the resource in cooperation with available resources.

When taken in conjunction with the accompanying drawings and the appended claims, other features and advantages of the present invention become apparent upon reading the following detailed description of the embodiments of the invention.

### BRIEF DESCRIPTION OF THE DRAWINGS

The invention illustrated in the drawings in which like reference characters designate the same or similar parts throughout the figures of which:

FIG. 1 illustrates a top level block schematic diagram of the preferred embodiment of the present invention,

FIG. 2 illustrates a block schematic diagram of the operation of the Time Tube data structure of FIG. 1,

FIG. 3 illustrates a block schematic diagram of the Time Tube data structure of FIG. 2 operating in concert with a Time Block data structure of FIG. 1,

FIG. 4 illustrates a block schematic diagram of the cancel operation of the Time Tube data structure and generated a Time Block remnant of FIG. 3,

FIG. 5 illustrates a block schematic diagram of the cancel operation of the Time Tube data structure and generated a Time Block availability of FIG. 3,

FIG. 6 illustrates a block schematic diagram of the Time Tube Attribute data structure of FIG. 1,

FIG. 7 illustrates a block schematic diagram of the Time Tube data structure generating available Time Blocks after an on-hold operation of FIG. 1,

FIG. 8 illustrates a block schematic diagram of the Time Tube data structure on-hold operation of FIG. 7.

### DETAILED DESCRIPTION OF THE PREFERRED EMBODIMENT

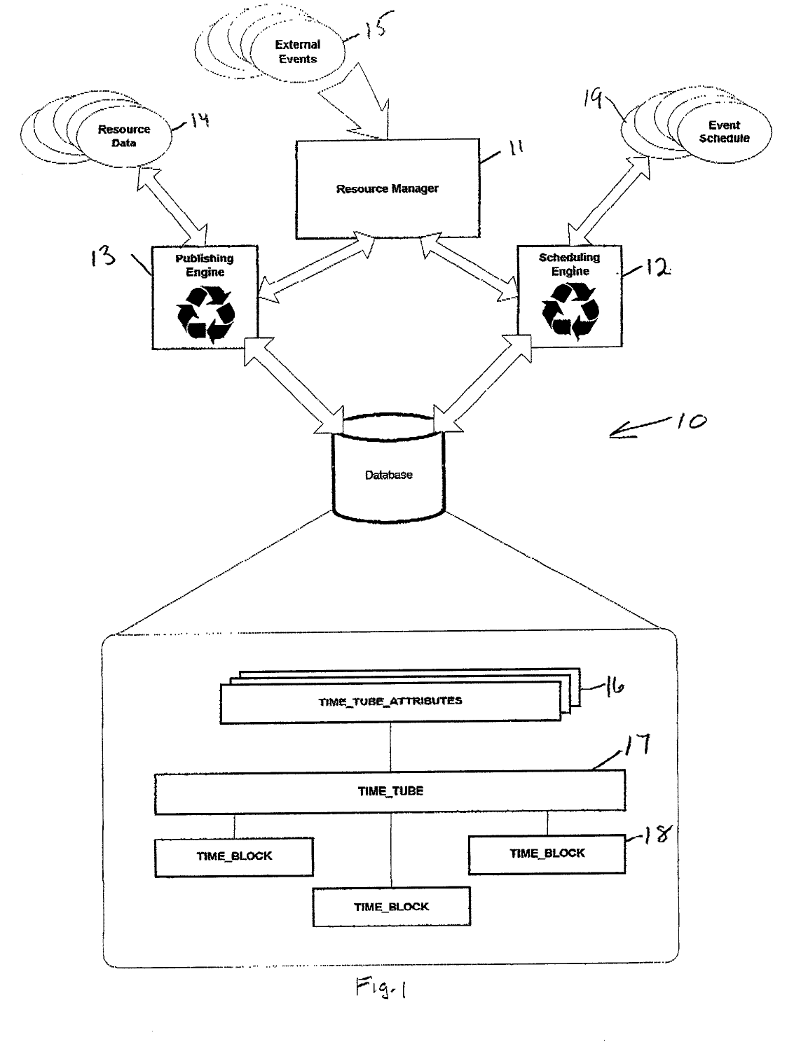

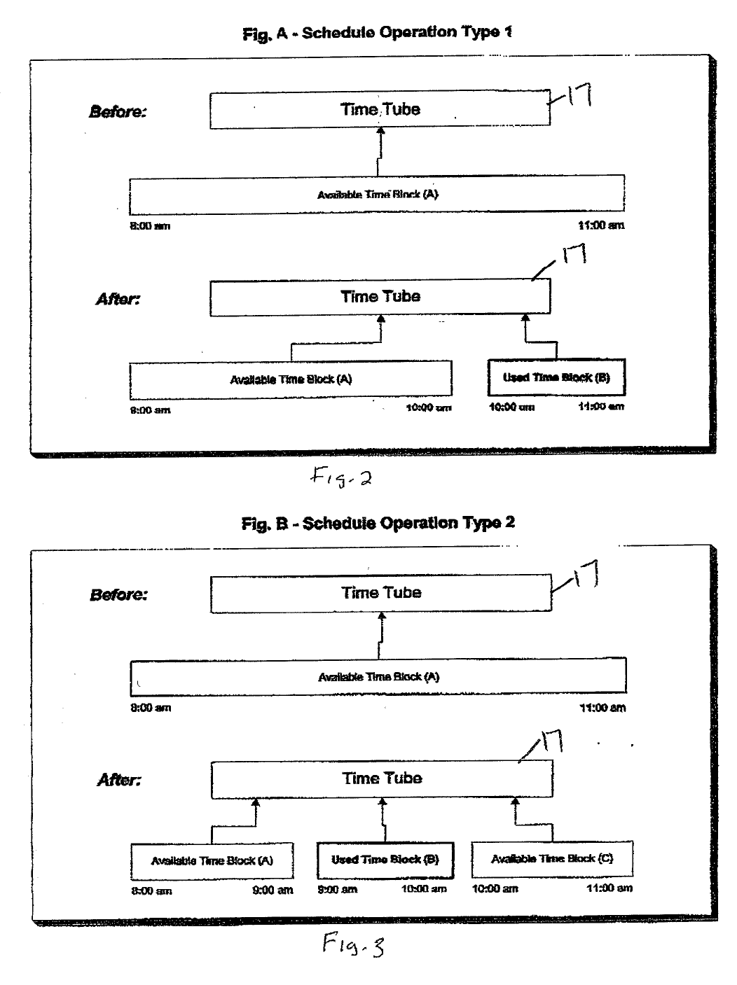

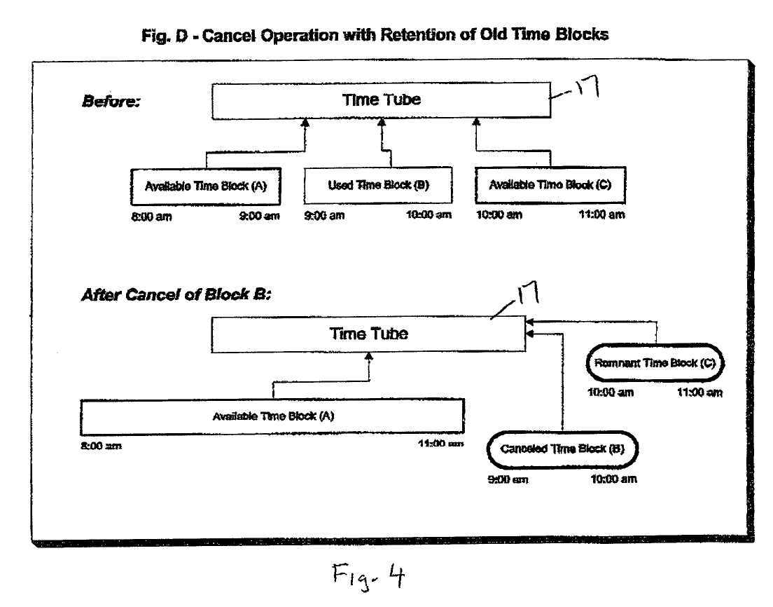

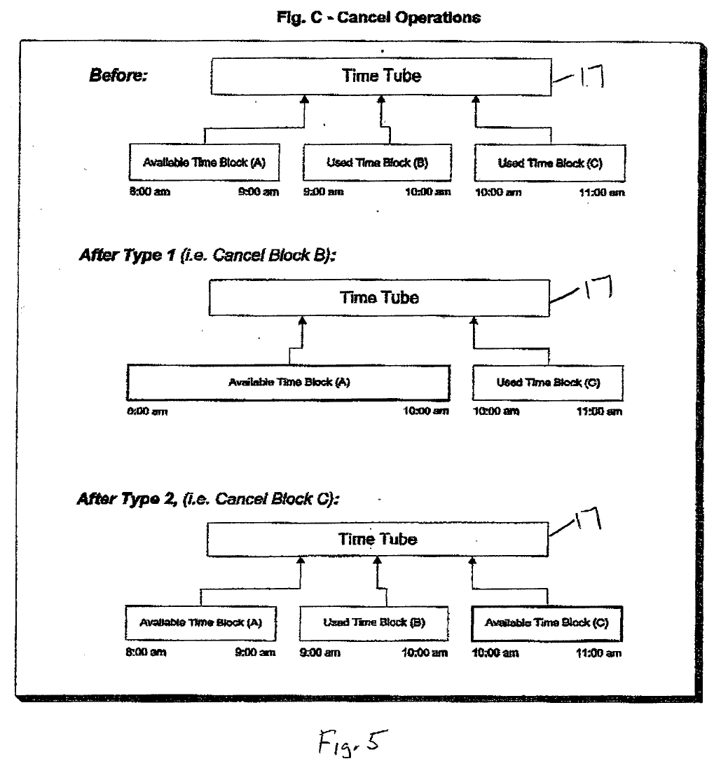

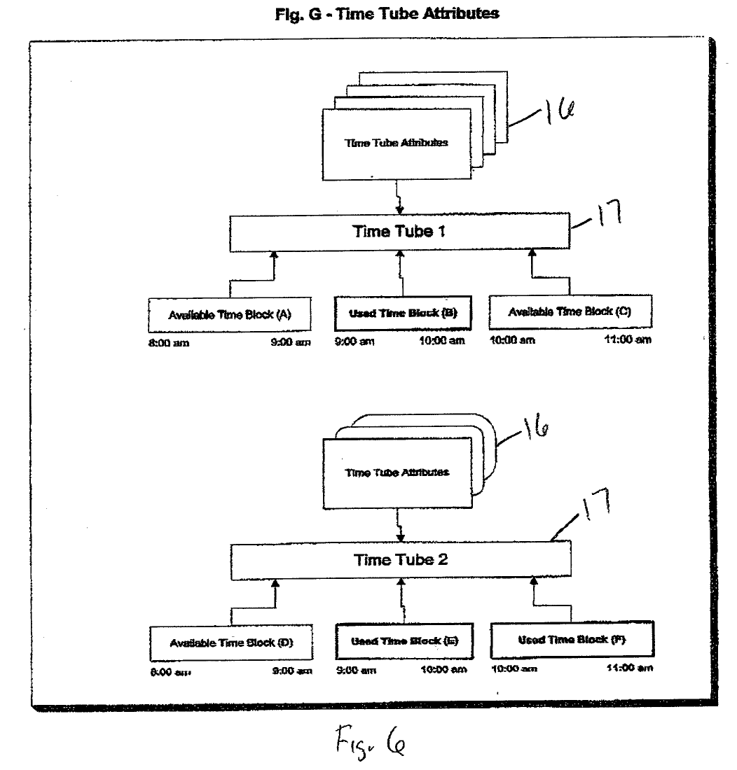

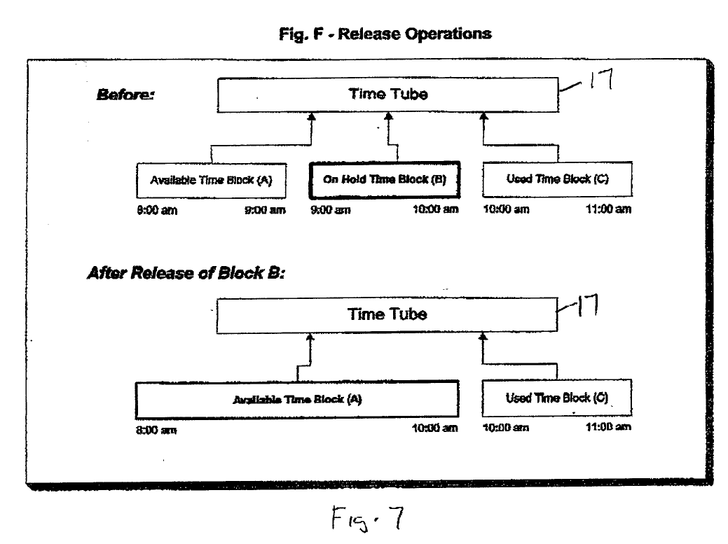

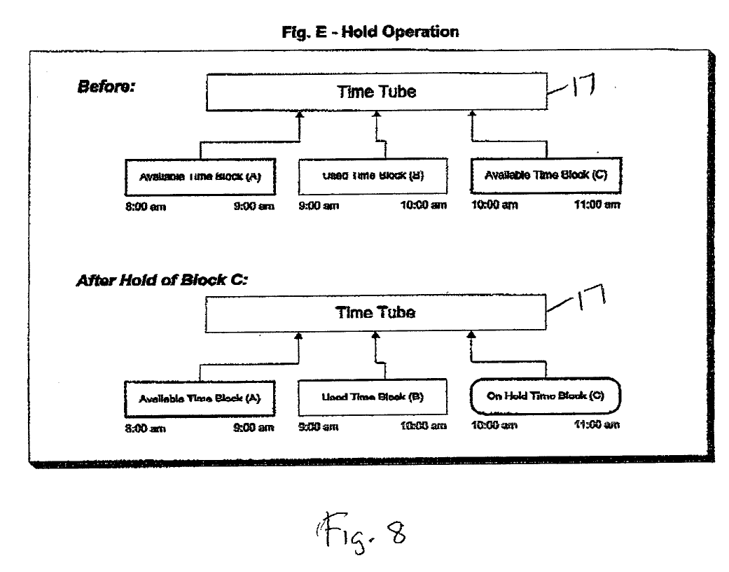

The preferred embodiment of the present invention is a system architecture for managing event driven activities 10, FIG. 1. A Resource Manager 11 in communication with a Publishing Engine 13, and Scheduling Engine 12 commands and controls the operational features of the present invention 10. The Resource Manager 11 receives a stimulus from an external event 15 indicating a request for a resource under the control of the present invention 10. The external event 15 may, if desired, be an activity, the results of an activity, or a user or recipient of a resource that is under control of the present invention 10. The stimulus may, if desired, be any convenient means of communication i.e., electronic, verbal recognition, or via the Postal Service. The Resource Manager 11 responds to the external event 15 by communicating a request for available or scheduled resources to the Publishing Engine 13. The Publishing Engine 13 is a processor or portion of the software program that determines how the resource data 14 is captured, received, and managed. Resource data is defined as a plurality of individual data structures each containing data attributes, time availability, or current scheduling of the intended resource pertinent to the execution of an event. For example, an event may be the installation of a particular or selected type of cable modem requested by a user. The resource data would contain the qualifications of individuals, companies, or on-line help screens capable of installing the particular or selected type of cable modem. The resource data would also contain the current scheduling and time availability of the individual who would install the cable modem.

The Publishing Engine 13, FIG. 1 has at least one Time Tube Attribute data structure(s) 16, at least one Time Tube data structure(s) 17, and at least one Time Block data structure(s) 18. The Time Tube Attribute data structure 16 has data fields containing the characteristics and potential availability of desired resources. The Time Tube Attribute data structure 16 is continually updated with new resource data and previously store data is updated. The Time Block data structure 18 has data fields containing the current disposition of a selected block or length of time of a selected Time Tube data structure 17. The timing function associated with the Time Block data structure 18 may, if desired, be selected from a group of data fields consisting of start, stop event timing, date/time, time availability of a resource, remnant time of the unused portion of a selected resource, canceled time of a resource, and on-hold time of a selected resource. The Time Block data structure 18 is continually updated via the Publishing Engine 13.

The Time Tube data structure 18, FIG. 1 has data fields containing a selected schedulable resource for a selected time period. The Time Tube data structure 17 and the Time Block data structure 18 have a parent-child relationship wherein the Time Tube is the parent and may have a plurality of Time block children. The fundamental relationship between Time Tube data structure 17 and the Time Block data structure 18 is that no two time blocks associated with the same parent Time Tube data structure have the same status i.e., the same availability, usage, on-hold, or overlapping start/stop times.

The Publishing Engine 13, FIG. 1 correlates the data contained in the Time Tube 17 with the request for the selected resource satisfying the requirements generated by the external event 15. The Publishing Engine 13 may, if desired, extend the correlation range of the data contained in the Time Tube 17. The extended range of data provides options concerning delivery of the selected resource to the external event 15.

The Scheduling Engine 12, FIG. 1 in concert with the Publishing Engine 13, generates an event schedule 19 reflecting the selected time blocks for event activity(s) i.e., the correlated resource data 14 and the external event 15. The Resource Manager 11 being in continual communication with Publishing Engine 13, the Scheduling Engine 12, and the external event 15 provides real time updates to the selected schedule generated by the Scheduling Engine 12.

Although only one exemplary embodiment of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. Means-plus-function clause is intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

All patents, applications, publications and other references are incorporated by reference herein in their entirety.

I claim:

1) A system architecture for managing event driven activities, selected event driven activities generating a request stimulus, the request stimulus indicating a desire for resource activity; comprising:
a) a computer with memory;
b) a Resource Manager program stored within said memory, said Resource Manager receiving the request stimulus, said Resource Manager generating a request for at least one available resource;
c) a Publishing Engine program stored within said memory, said Publishing Engine in communication with said Resource Manager, said Publishing Engine receiving said request for said available resource, said Publishing Engine having at least one data structure responsive to said request for said available resource;
d) said Resource Manager generating a request for an event activity schedule; and,
e) a Scheduling Engine program stored within said memory, said Scheduling Engine in communication with said Resource Manager, said Scheduling Engine having at least one data structure responsive to said request for an event activity schedule, said data structure transforming said available resources into at least one event scheduled activity.

2) The system architecture for managing event driven activities of claim 1 wherein, said computer with memory is a database.

3) The system architecture for managing event driven activities of claim 2, wherein said Resource Manager comprises a plurality of data structures for receiving a plurality of request stimuli all indicating a desire for resource activity.

4) The system architecture for managing event driven activities of claim 3, wherein said Resource Manager further comprising at least one priority data structure, said priority data structure transforming said request stimuli into a demand resource activity.

5) The system architecture for managing event driven activities of claim 3, wherein said Publishing Engine further comprises:
a) a Time Tube data structure having at least one data field containing a Time Tube Attribute data structure and a Time Block data structure, said Time Tube data structure transforming said Time Tube Attribute data structure and said Time Block data structure into available resource data transmittable to said Scheduling Engine.
b) said Time Tube Attribute data structure having at least one data field containing a profile of an available resource;
c) said Time Block data structure having at least one data field containing current disposition of said resource data;
wherein said Time Tube data structure represents a schedulable resource derived from said Time Tube Attribute data structure, said Time Block data structure providing timing constraints of said available resource data.

6) The system architecture for managing event driven activities of claim 5, wherein said Time Block's timing constraints are selected from a group consisting of start time, stop time, start date, stop date, availability status, resource usage, resource cancellation, event on-hold, or remnant.

7) The system architecture for managing event driven activities of claim 6, wherein said profile of an available resource profile comprises event attributes correlated to resource attributes.

8) The system architecture for managing event driven activities of claim 6, wherein said profile of an available resource profile comprises resource attributes correlated to event attributes.

9) A method for managing event driven activities, the event driven activities generating a request stimulus, the request stimulus indicating a desire for resource activity, comprising:
a) receiving the request stimulus by a Resource Manager, said Resource Manager responsive to the requested stimulus and generating a request for an available resource;
b) communicating said request for an available resource to a Publishing Engine, said Publishing Engine having at least one data structure responsive to said request for said available resource;
c) communicating a request for schedule activity to a Scheduling Engine, said Scheduling Engine having at least one data structure responsive to said request for schedule activity, said data structure transforming said available resource into at least one event scheduled activity.

10) A database for managing event driven activities, the database having data structure means for storing resource data derived from an external source, data structure means for generating an activity schedule, and data structure means for receiving external request stimuli indicating desires for resource activity; comprising:
a) a plurality of Time Tube data structures stored on the database, each said Time Tube data structure having a first data field containing selected resource data, said Time Tube data structure having a second data field containing selected timing data;
b) said Time Tube data structures transforming said first data field and said second data field into an available resource data structure;
whereby a means for generating a schedule of activities is formulated from said transformed Time Tube data structures.
